(19) United States
(12) Patent Application Publication
(10) Pub. No.: US 2016/0301863 A1
(43) Pub. Date: Oct. 13, 2016

(54) IMAGE PROCESSING SYSTEM FOR GENERATING A SURROUND-VIEW IMAGE

(71) Applicant: Caterpillar Inc., Peoria, IL (US)

(72) Inventors: Peter PETRANY, Dunlap, IL (US); Rodrigo SANCHEZ, Dunlap, IL (US); Douglas HUSTED, Secor, IL (US)

(73) Assignee: Caterpillar Inc., Peoria, IL (US)

(21) Appl. No.: 14/683,800

(22) Filed: Apr. 10, 2015

(51) Int. Cl. H04N 5/232; B60R 1/00; H04N 5/247

(52) U.S. Cl. CPC H04N 5/23238; H04N 5/247; H04N 5/23293; B60R 1/00

(57) ABSTRACT

An image processing system is disclosed for a machine having a first section pivotally connected to a second section. The image processing system may include a plurality of cameras mounted on the first section and configured to capture image data of an environment around the machine. The image processing system may also include a sensor, a display, and a processing device. The processing device may obtain, from the sensor, information indicative of a rotation of the first section relative to the second section. Based on the information, the processing device may adjust the image data to account for the rotation of the first section relative to the second section. In addition, the processing device may use the adjusted image data to generate a top-view image of the environment around the machine. The processing device may also render the top-view image on the display.

### TECHNICAL FIELD

This disclosure relates generally to image processing systems and methods and, more particularly, to image processing systems and methods for generating a surround-view image in articulated machines.

### BACKGROUND

Various machines such as excavators, scrapers, articulated trucks and other types of heavy equipment are used to perform a variety of tasks. Some of these tasks involve moving large, awkward, and heavy loads in a small environment. And because of the size of the machines and/or the poor visibility provided to operators of the machines, these tasks can be difficult to complete safely and effectively. For this reason, some machines are equipped with image processing systems that provide views of the machines' environments to their operators.

Such image processing systems assist the operators of the machines by increasing visibility, and may be beneficial in situations where the operators' fields of view are obstructed by portions of the machines or other obstacles. Conventional image processing systems include cameras that capture different areas of a machine's environment. These areas may then be stitched together to form a partial or complete view of the environment around the machine. Some image processing systems use a top-view transformation on the captured images to display a representative view of the associated machine at a center of the display (known as a “bird's eye view”). However, the bird's eye view used in conventional image processing systems may be confusing in articulated machines having several reference frames, such as in articulated trucks and excavators. When these types of machines turn or swing, the representative view on the display will rotate with respect to the associated reference frame. This rotation may confuse the operators of the machines, making it difficult to distinguish the true position of objects in the environment of the machines. The confusion could be greater if one of the objects moves irrespective of the machines. For example, one of the objects may be a human or a different mobile machine.

One attempt to create a bird's eye view of articulated working machines having rotating reference frames is disclosed in U.S. Patent Publication No. 2014/0088824 (the '824 publication) to Ishimoto. The system of the '824 publication includes means for obtaining from the steering wheel the angle of bending between a vehicle front section and a vehicle rear section, which is used to create a representative image of the vehicle. The system of the '824 publication also includes means for converting the camera images to the bird's eye view images, and means for converting the bird's eye view images to a composite bird's eye view image. The composite bird's eye view image and vehicle image are inputted to a display image creation means to create an image of the surroundings to be displayed on a monitor.

While the system of the '824 publication may be used to process camera images for articulated machines, it requires a converting process for each camera for converting the camera images to the bird's eye view images, and a separate composing process for converting the bird's eye view images to a composite bird's eye view image. Consequently, the amount of pixels needed to be processed in each image, the converting process, and the composing process employed by the system of the '824 publication may be very computationally expensive.

The disclosed methods and systems are directed to solve one or more of the problems set forth above and/or other problems of the prior art.

### SUMMARY

In one aspect, the present disclosure is directed to an image processing system for a machine having a first section pivotally connected to a second section. The image processing system may include a plurality of cameras mounted on the first section and configured to capture image data of an environment around the machine. The image processing system may further include at least one sensor mounted on the machine and configured to obtain information indicative of a rotation of the first section relative to the second section. The image processing system may also include a display mounted on the first section of the machine and at least one processing device in communication with the plurality of cameras, the at least one sensor, and the display. Based on the information from the at least one sensor, the at least one processing device may be configured to adjust at least part of the image data to account for the rotation of the first section relative to the second section. The at least one processing device may be configured to use the adjusted image data to generate a top view image of the environment around the machine and to render the top-view image on the display.

In another aspect, the present disclosure is directed to a method for displaying a top-view image of an environment around a machine having a first section pivotally connected to a second section. The method may include capturing image data of the environment around the machine. The method may also include obtaining, from at least one sensor, information indicative of a rotation of the first section relative to the second section. Based on the information, the method may further include adjusting at least part of the image data to account for the rotation of the first section relative to the second section. The method may further include using the adjusted image data to generate a top-view image of the environment around the machine, and rendering the top-view image for display.

In yet another aspect, the present disclosure is directed to a computer readable medium having executable instructions stored thereon for completing a method for displaying a top-view image of an environment around a machine having a first section pivotally connected to a second section. The method may include capturing image data of the environment around the machine. The method may also include obtaining from, at least one sensor, information indicative of a rotation of the first section relative to the second section. Based on the information, the method may further include adjusting at least part of the image data to account for the rotation of the first section relative to the second section. The method may further include using the adjusted image data to generate a top-view image of the environment around the machine, and rendering the top-view image for display.

### BRIEF DESCRIPTION OF THE DRAWINGS

FIG. 1A is a diagrammatic side view illustration of an exemplary articulated truck consistent with the disclosed embodiments;

FIG. 1B is a diagrammatic side view illustration of an exemplary excavator consistent with the disclosed embodiments;

FIGS. 2A-2C are diagrammatic illustrations of a display device of the articulated truck of FIG. 1A;

FIGS. 3A-3C are diagrammatic illustrations of a display device of the excavator of FIG. 1B;

FIG. 4 is a flowchart showing an exemplary process for displaying a surround-view image of an environment around an articulated machine; and

FIGS. 5A-5B are diagrammatic illustrations of a process for stitching image data using a virtual three-dimensional surface.

### DETAILED DESCRIPTION

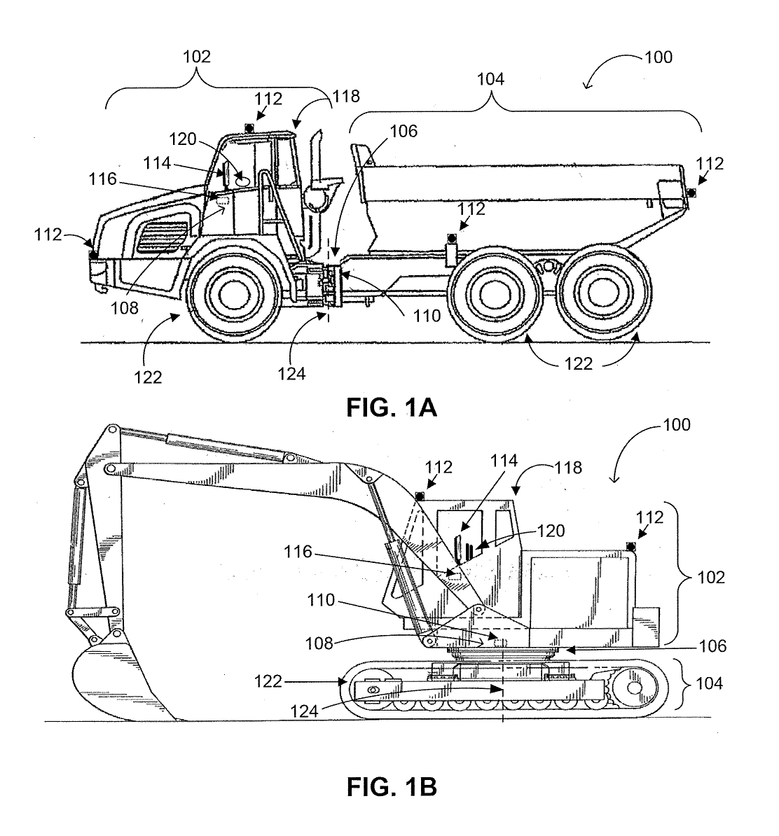

The present disclosure relates to image processing systems and methods for an articulated machine 100 (hereinafter referred to as “machine 100”). FIG. 1A and FIG. 1B schematically illustrate two examples of machine 100 consistent with the disclosed embodiments. In the example depicted in FIG. 1A, machine 100 is an articulated truck. In the example depicted in FIG. 1B, machine 100 is an excavator. It is contemplated, however, that machine 100 may embody other types of mobile machines, if desired, such as a scraper, a wheel loader, a motor grader, or any another machine known in the art.

In some embodiments, machine 100 may include a first section 102, a second section 104, an articulation joint 106, and an image processing system 108. Image processing system 108 may include one or more of the following: at least one sensor 110, a plurality of cameras 112, a display device 114, and a processing device 116. First section 102 may include multiple components that interact to provide power and control operations of machine 100. In one embodiment, first section 102 may include an operator compartment 118 having therein a navigation device 120 and display device 114. In addition, first section 102 may or may not include at least one ground engaging element 122. For example, in FIG. 1A, first section 102 includes wheels. But in FIG. 1B, first section 102 is located above second section 104 and does not touch the ground. Second section 104 may include multiple components tied to the mobility of machine 100. In one embodiment, second section 104 includes ground engaging element 122, for example, in FIG. 1A second section 104 includes wheels and in FIG. 1B second section 104 includes tracks.

In some embodiments, machine 100 may include articulation joint 106 that operatively connects first section 102 to second section 104. The term “articulation joint” may include an assembly of components that cooperate to pivotally connect second section 104 to first section 102, while still allowing some relative movements (e.g., bending or rotation) between first section 102 and second section 104. When an operator moves machine 100 by operating navigation device 120, articulation joint 106 allows first section 102 to pivot horizontally and/or vertically relative to second section 104. One skilled in the art may appreciate that the relative movement between first section 102 and second section 104 may exist in any manner.

Sensor 110 may be configured to measure the articulation state of machine 100 during operation. The term “sensor” may include any type of sensor or sensor group configured to measure one or more parameter values indicative of, either directly or indirectly, the angular positions of first section 102 and second section 104. For example, sensor 110 may include a rotational sensor mounted in or near articulation joint 106 for measuring articulation angles of machine 100. Alternatively, sensor 110 may determine the articulation angles based on a data from navigation device 120. In some embodiments, sensor 110 may generate information indicative of the rotation of first section 102 relative to second section 104. The generated information may include, for example, the current articulation angle state of machine 100. The articulation angle state may include an articulation angle around a vertical axis 124, as well as an articulation angle around a horizontal axis (not shown). The generated information may also include a current inclination angle of first section 102, a current inclination angle of second section 104, a current direction of machine 100, values associated with a velocity of the rotation, and values associated with an acceleration of the rotation. One skilled in the art will appreciate that machine 100 may include any number and type of sensors to measure various parameters associated with machine 100.

In some embodiments, machine 100 may include a plurality of cameras 112 to capture image data of an environment around machine 100. Cameras 112 may be attached or mounted to any part of machine 100. The term “camera” generally refers to a device configured to capture and record image data, for example, still images, video streams, time lapse sequences, etc. Camera 112 can be a monochrome digital camera, a high-resolution digital camera, or any suitable digital camera. Cameras 112 may capture image data of the surroundings of machine 100, and transfer the captured image data to processing device 116. In some cases, cameras 112 may capture a complete surround view of the environment of machine 100. Thus, the cameras 112 may have a 360-degree horizontal field of view. In one embodiment, cameras 112 include at least two cameras mounted on first section 102 and at least two additional cameras 112 mounted on second section 104. For example, the articulated truck of FIG. 1A has six cameras 112 for capturing the environment around the articulated truck. Not all of the cameras 112 are shown in the figure. The articulated truck includes two cameras 112 mounted on each side, one camera 112 mounted on the front of the truck, and another camera 112 mounted on the back of the truck. Therefore, the articulated truck includes three cameras 112 on first section 102 and three cameras 112 on second section 104. Alternatively, cameras 112 may include at least four cameras 112 mounted on first section 102 and zero cameras 112 on second section 104. For example, the excavator of FIG. 1B has four cameras 112 mounted on first section 102. Not all of the cameras 112 are shown in the figure. The excavator includes a camera 112 mounted on each corner of its frame. Therefore, the excavator includes cameras 112 only on first section 102. One skilled in the art will appreciate that machine 100 may include any number of cameras 112 arranged in any manner.

In some embodiments, display device 114 may be mounted on first section 102 of machine 100. The term “display device” refers to one or more devices used to present an output of processing device 116 to the operator of machine 100. Display device 114 may include a single-screen display, such as an LCD display device, or a multi-screen display. Display device 114 can include multiple displays managed as separate logical displays. Thus, different content can be displayed on the separate displays, although part of the same physical screen. Consistent with disclosed embodiments, display device 114 may be used to display a representation of the environment around machine 100 based on image data captured by cameras 112. In addition, display device 114 can encompass a touch sensitive screen. Thus, display device 114 may have the capability to input data and to record information.

Processing device 116 may be in communication with sensor 110, cameras 112, and display device 114. The team “processing device” may include any physical device having an electric circuit that performs a logic operation on input. For example, processing device 116 may include one or more integrated circuits, microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. In some embodiments, processing device 116 may be associated with a software product stored on a non-transitory computer readable medium and comprising data and computer implementable instructions, which when executed by processing device 116, cause processing device 116 to perform operations. For example, the operations may include displaying a surround-view image to the operator of machine 100. The non-transitory computer readable medium may include a memory, such as RAM, ROM, flash memory, a hard drive, etc. The computer readable memory may also be configured to store electronic data associated with operation of machine 100, for example, image data associated with a certain event.

Consistent with embodiments of the present disclosure, processing device 116 may be configured to perform a bird's eye view transformation on image data captured by cameras 112. In addition, processing device 116 may be configured to perform an image stitching process to combine the image data captures by cameras 112 and to generate a 360-degree surround-view around the environment of machine 100.

The bird's eye view transformation utilizes image data captured from different viewpoints to reflect a different vantage point above machine 100. Those of ordinary skill in the art of image processing will recognize that there are numerous methods for performing such transformations. One method includes performing scaled transformation of a captured rectangular image to a trapezoid image to simulate the loss of perspective. The loss of perspective happens because the azimuth angle of the virtual viewpoint is larger than the actual viewpoint of cameras 112 mounted on machine 100. The trapezoid image may result from transforming each row of the x-axis gradually with increased compression starting from the upper edge of the picture frame, with increasing compression towards the bottom of the frame. Additionally, a subsequent image acquired later in time may be similarly transformed to overlap the earlier-acquired image, which can increase the resolution of the trapezoid image.

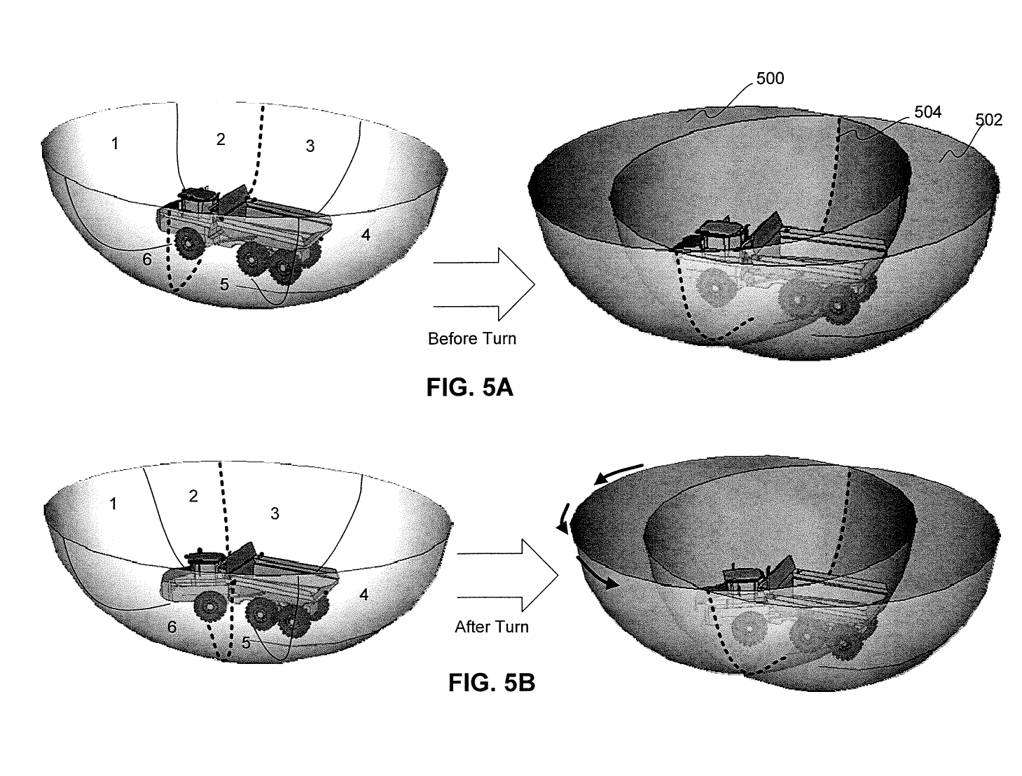

The image stitching process may be used to merge the trapezoid images originated from cameras 112 to create a 360-degree surround-view image of the actual environment of machine 100. The process may take into account the relative position of the actual cameras' viewpoint and map the displacement of pixels in the different images. Typically, a subgroup of pixels in one image will be overlaid with a subgroup of pixels in another image. One skilled in the art will appreciate that the images can be stitched before or after the bird's eye view transformation. Additional details on the image stitching process are provided below with reference to FIG. 5A and FIG. 5B. In some embodiments, virtual features, such as a representation of machine 100, border lines separating regions in the image, and icons representing one or more identified objects, may be overlaid on the penultimate composite images to form the final surround-view image. For example, a representation of machine 100 may be overlaid at a center of the 360-degree surround-view image.

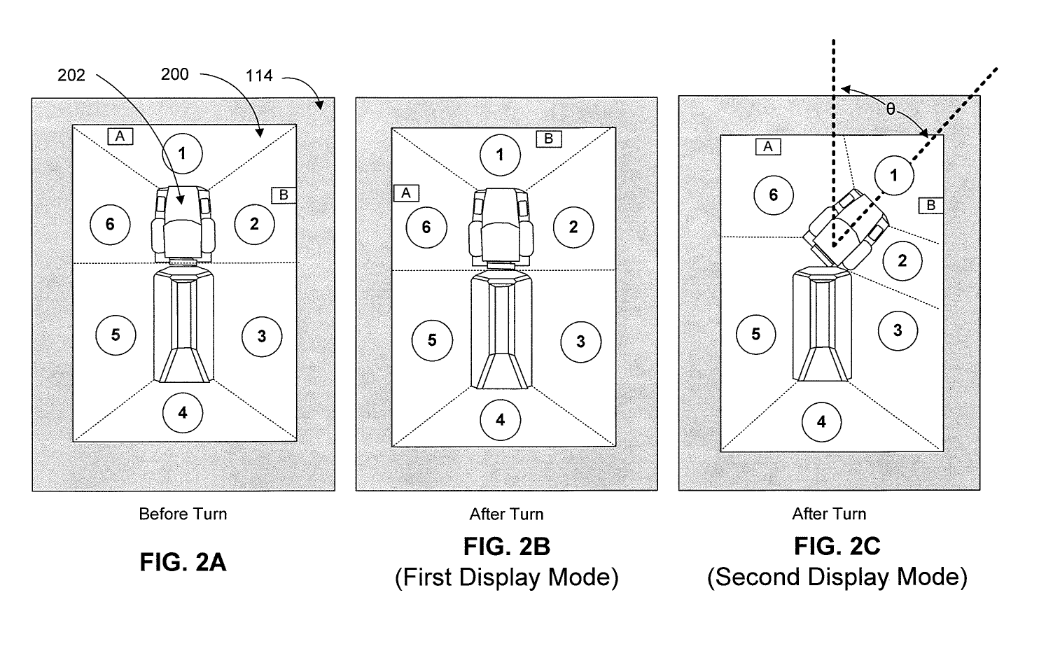

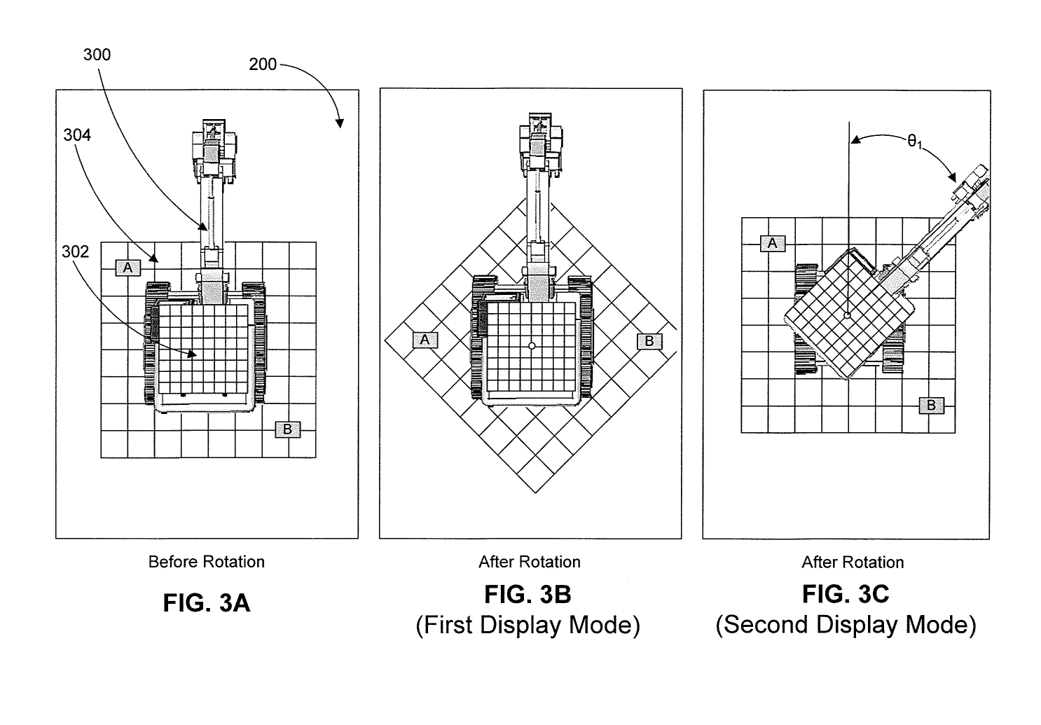

FIGS. 2A-2C and FIGS. 3A-3C illustrate different presentations of the 360-degree surround-view image as shown on display device 114 of machine 100. In FIGS. 2A-2C machine 100 is represented by the articulated truck, and in FIGS. 3A-3C machine 100 is represented by the excavator. Specifically, FIG. 2A and FIG. 3A are diagrammatic representations of exemplary surround-view images of machine 100 before articulation or rotation of first section 102. FIG. 2B and FIG. 3B are diagrammatic representations of exemplary surround-view images of machine 100 after the articulation or rotation of first section 102, according to a first display mode. FIG. 2C and FIG. 3C are diagrammatic representations of exemplary surround-view images of machine 100 after the articulation or rotation of first section 102, according to a second display mode.

In some embodiments, the first display mode or the second display mode may be predetermined as a default display mode for machine 100. However, the operator of machine 100 may switch between the two display modes during operation of machine 100. In addition, in case display device includes multiple screens, the first display mode and the second display mode may be presented simultaneously.

As illustrated in FIG. 2A, display device 114 may have a screen 200 configured to present a real time display of the actual environment around the articulated truck from a bird's eye view. The surround-view image may be the result of the bird's eye view transformation and the image stitching process, as described above. Screen 200 may show, at the center of the image, a virtual representation 202 of the articulated truck. Screen 200 may also show sections 1 to 6 that correspond with image data captured by six different cameras 112, and two objects (Object A and Object B) in the environment of the articulated truck. The dotted border lines between the numbered sections may or may not be presented on display device 114. When the articulated truck drives straight, Object A and Object B may move downward, while virtual representation 202 may remain at a center of screen 200. The term “object” refers to a person or any non-translucent article that may be captured by cameras 112, for example Object A and Object B. The term object may include static objects, for example rocks, trees, and traffic poles. Additionally, the teen object may include movable objects, for example pedestrians, vehicles, and autonomous machines.

FIG. 2B illustrates how a real time display of the articulated truck would look using the first display mode during a right hand-turn. The first mode of display includes presenting a surround-view image based on the original image data (“as-captured”). For the purposes of illustration, only the bending movement of first section 102 may be taken to account. In reality, when the articulated truck turns it would also have a longitudinal movement, which will cause the presentation of Object A and Object B to also move downward. Before the articulated truck had turned (FIG. 2A), Object A was presented in sector 1 and Object B was presented in sector 2. When the articulated truck turns right, first section 102 bends causing a change to the field of views of cameras 112 mounted on first section 102. Therefore, after the turn, Object A and Object B would be in field of views of different cameras 112. Accordingly, after the turn, the surround-view image displayed on screen 200, using the first display mode, presents Object A in sector 6 and Object B in sector 1.

FIG. 2C illustrates how a real time display of the articulated truck would look using the second display mode during a right-hand turn. The second mode of display includes presenting a surround-view image based on the adjusted image data. As described above, for the purposes of illustration, only the bending movement of first section 102 may be taken into account. According to one embodiment of the present disclosure, processing device 116 may obtain information indicative of the rotation of first section 102 relative to second section 104, for example, an angle θ. Based on this information, processing device 116 may adjust the image data from cameras 112 mounted on first section 102, to account for the rotation of first section 102 relative to second section 104. The adjustment of the image data may enable displaying of Object A and Object B on screen 200 at their actual position, from an operator's perspective. Additional details on the adjustment on the image data are provided below.

FIGS. 3A-3C are structurally organized similarly to FIGS. 2A-2C, but machine 100 is represented by the excavator. As illustrated in FIG. 3A, screen 200 is configured to present a real time display of the environment around the excavator from a bird's eye view. Screen 200 may also display a virtual representation 300 of the excavator, a first reference frame 302 that corresponds to first section 102, and a second reference frame 304 that corresponds to the environment around the excavator. The environment around the excavator may include at least one object (e.g., Object A and Object B). FIG. 3B illustrates how a real time display of the excavator would look using the first display mode when the excavator swings in a clockwise direction. Since all of cameras 112 are located on first section 102, first reference frame 302 (first section) remains static and second reference frame 304 (the environment) moves in a counter-clockwise direction opposite to the rotation of first section 102.

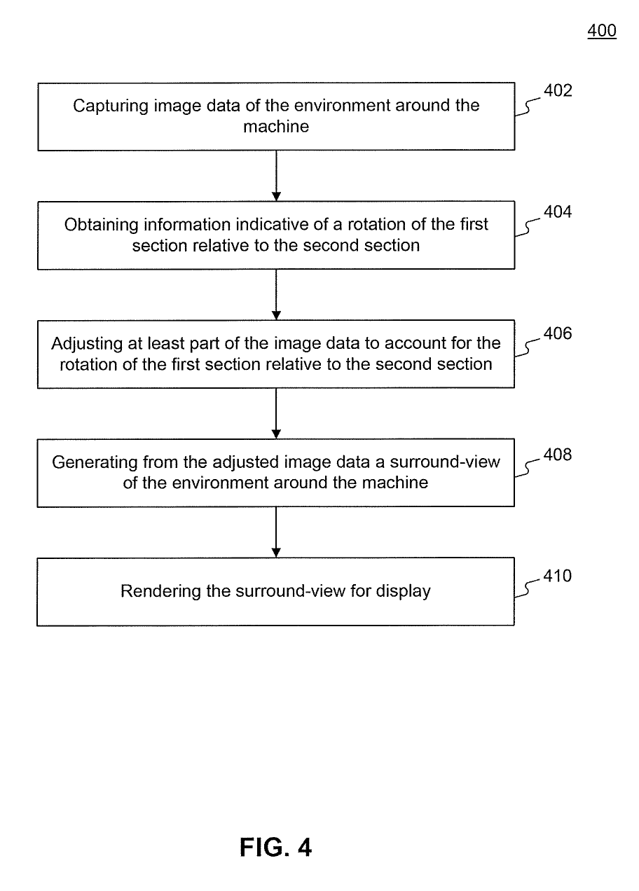

FIG. 3C illustrates how a real time display of the excavator would look using the second display mode when the excavator swings in a clockwise direction. According to one embodiment of the present disclosure, processing device 116 may obtain information indicative of the rotation of first section 102 relative to second section 104, for example, an angle θ₁. Based on this information, processing device 116 can adjust the captured image data to compensate for the rotation of first reference frame 302 relative to second reference frame 304. The adjustment of the image data may enable displaying of second reference frame 304 static on screen 200, such that Object A and Object B will remain at their actual position from an operator's perspective. A detailed explanation of the process of adjusting the image data is provided below with reference to FIG. 4.

### INDUSTRIAL APPLICABILITY

The disclosed image processing system 108 may be applicable to any machine that includes one or more articulation joints connecting different sections together. The disclosed image processing system 108 may enhance operator awareness by rendering a 360-degree surround-view image that includes a static view of the environment around machine 100. In particular, the captured image data is adjusted to compensate for the rotation of first section 102 relative to second section 104. Because the disclosed image processing system may display a static view of the environment around machine 100, a greater depth perception may be realized in the resulting surround-view image. This greater depth perception may assist the operator to distinguish the true position of first section 102 and second section 104 relative to objects in the environment around machine 100.

FIG. 4 is a flow chart illustrating an exemplary process 400 for displaying a surround-view image of the environment around machine 100. At step 402, image processing system 108 may use cameras 112 to capture image data of the environment around machine 100. In one embodiment, cameras 112 may include at least two cameras 112 mounted on the first section and at least one camera 112 mounted on the second section configured to capture image data of an environment around the machine. In an alternative embodiment, all of cameras 112 are mounted on first section 102 or second section 104. The environment may include at least one object, for example, Object A and Object B as depicted in FIGS. 2A-2C and FIGS. 3A-3C.

At step 404, image processing system 108 may obtain information indicative of the rotation of first section 102 relative to second section 104. The rotation of first section 102 relative to second section 104 may be relative to a horizontal axis, relative to a vertical axis, or relative to a combination of horizontal and vertical movement. In one embodiment, image processing system 108 may obtain part or all of the information solely by processing the image data captured by cameras 112. For example, processing device 116 may estimate motion between consecutive image frames and calculate disparities in pixels between the frames to obtain the information indicative of a rotation of first section 102 relative to second section 104. The information obtained from processing the image data may be used to determine a plurality of rotation values, for example, by detecting in the image data a ground plane and comparing at least two consecutive images to identify pixel changes. The term “rotation value” may include any value of parameter that may be associated with calculating the position of first section 102 relative to second section 104. For example, the plurality of rotation values may include two or more of the following: a value associated with a horizontal angle of the rotation, a value associated with a vertical angle of the rotation, a value associated with a direction of the rotation, a value associated with a velocity of the rotation, and a value associated with an acceleration of the rotation. In an alternative embodiment, image processing system 108 may obtain at least part of the information indicative of the rotation from sensor 110. The information obtained from sensor 110 may also be used to determine a plurality of rotation values, for example, by combining information from navigation device 120 and sensor 110.

At step 406, image processing system 108 may adjust at least part of the image data to account for the rotation of first section 102 relative to second section 104. In one embodiment, the image data is captured only by cameras 112 mounted on first section 102. Thus, image processing system 108 may adjust all of the image data to account for the rotation. In a different embodiment, the image data is captured by cameras 112 mounted on both of first section 102 and second section 104. Thus, image processing system 108 may adjust only part of the image data to account for the rotation. As explained above, adjusting the image data may enable displaying the environment around machine 100 in a static manner. In one embodiment, when the first section rotates in a first direction relative to the second section, the adjustment of the at least part of the image data includes correcting the at least part of the image data in an opposing second direction by an equal amount. For example, when the excavator rotates clockwise, first section 102 rotates right at a number of degrees relative to second section 104. The adjustment of the at least part of the image data may include correcting the at least part of image data leftward by the same number of degrees. As another example, when the articulated truck passes a bump on the road, first section 102 bends up at a number of degrees relative to second section 104. The adjustment of the at least part of the image data may include correcting the at least part of the image data downward by the same number of degrees.

At step 408, image processing system 108 may generate from the adjusted image data a surround-view image of the environment around machine 100. The surround-view image may present a movement of first section 102 relative to second section 104 and/or relative to the at least one object. FIG. 2C and FIG. 3C depict examples of 360-degree surround-view images of the environment around machine 100. In some embodiments, a surround-view image may present second section 104 static while first section 102 rotates. However, in other embodiments, the surround-view image may present the at least one object static while first section 102 rotates. This may occur when both first section 102 and second section 104 move. At step 410, image processing system 108 may render the surround-view image for display. The surround-view image may include a 360-degree view of the environment around machine 100.

FIGS. 5A-5B illustrate the use of a virtual three-dimensional surface in the process of stitching image data from different cameras 112. In the disclosed embodiment, processing device 116 may mathematically project the image data associated with cameras 112 mounted on first section 102 and image data associated with cameras 112 mounted on second section 104, to create a 3-D representation of the environment around machine 100. The virtual three-dimensional surface may include a single geometry (e.g., a hemisphere), with machine 100 being located at an internal pole or center. Alternatively, the virtual three-dimensional surface may include a first geometry 500 having first section 102 located at its center, and a second geometry 502 having second section 104 located at its center. Each of first geometry 500 and second geometry 502 may be a hemisphere created to have any desired parameters, for example a desired diameter, a desired wall height, etc.

In some embodiments, processing device 116 may mathematically project image data associated with first section 102 and second section 104 onto the virtual three-dimensional surface. For example, processing device 116 may transfer pixels of the captured 2-D digital image data to 3-D locations on first geometry 500 and second geometry 502 using a predefined pixel map or look-up table stored in a computer readable data file. The image data may be mapped directly using a one-to-one or a one-to-many correspondence. It should be noted that, although a look-up table is one method by which processing device 116 may create a 3-D surround view of the actual environment of machine 100, those skilled in the relevant art will appreciate that other methods for mapping image data may be used to achieve a similar effect.

FIG. 5A and FIG. 5B illustrate mathematically projecting image data associated with cameras 112 mounted on first section 102 onto first geometry 500, and mathematically projecting the image data associated with cameras 112 mounted on second section 104 onto geometry 502. FIG. 5A illustrates mathematically projecting image data captured when first section 102 and second section 104 are aligned (i.e., before rotation or articulation). FIG. 5B illustrates mathematically projecting the image data captured, from the same cameras 112, when first section 102 is not aligned with second section 104 (i.e., after rotation or articulation). The result of the rotation of first section 102 relative to second section 104 is shown when comparing the angles of view of cameras 112. For example, before the rotation (FIG. 5A) the angle of view of camera 112 associated with sector 2 was substantially the same as the angle of view of camera 112 associated with sector 6. However, after the rotation (FIG. 5B), the angle of view of camera 112 associated with sector 6 grows, while the angle of view of camera 112 associated with sector 2 narrows. This change in the angle of view of cameras 112 associated with sectors 2 and 6 is also shown in FIGS. 2A and 2C.

In some embodiments, processing device 116 may use the information indicative of the rotation of first section 102 relative to second section 104 (e.g., information obtained from image processing or from sensor 110) to adjust the position of first geometry 500 relative to second geometry 502. The adjustment of the position of first geometry 500 relative to second geometry 502 enables compensation of the rotation of first section 102 relative to second section 104, and determination of stitch lines 504 between first geometry 500 and second geometry 502. In addition, processing device 116 may be configured to generate virtual objects, for example Object A and Object B (not shown) within first geometry 500 and second geometry 502 based on the image data. Processing device 116 may generate virtual objects of about the same size as actual objects detected in the actual environment of machine 100, and mathematically place the virtual objects at the same locations within the first geometry 500 and second geometry 502, relative to the location of machine 100.

It will be apparent to those skilled in the art that various modifications and variations can be made to the disclosed image processing system 108. Other embodiments will be apparent to those skilled in the art from consideration of the specification and practice of the disclosed parts forecasting system. It is intended that the specification and examples be considered as exemplary only, with a true scope being indicated by the following claims and their equivalents.

What is claimed is:

1. An image processing system for a machine having a first section pivotally connected to a second section, the image processing system comprising:
a plurality of cameras mounted on the first section and configured to capture image data of an environment around the machine;
at least one sensor mounted on the machine and configured to obtain information indicative of a rotation of the first section relative to the second section;
a display mounted on the first section of the machine; and
a processing device in communication with the plurality of cameras, the at least one sensor, and the display, the processing device being configured to:
based on the information, adjust at least part of the image data to account for the rotation of the first section relative to the second section;
use the adjusted image data to generate a top-view image of the environment around the machine; and
render the top-view image on the display.

2. The image processing system of claim 1, wherein the first section includes an operator compartment and the second section includes at least one ground engaging element.

3. The image processing system of claim 1, wherein the plurality of cameras includes at least four cameras mounted on the first section.

4. The image processing system of claim 1, further comprising a camera mounted on the second section, and the processing device is further configured to adjust image data that originated from only the plurality of cameras.

5. The image processing system of claim 1, further comprising a plurality of cameras mounted on the second section.

6. The image processing system of claim 1, wherein the processing device is further configured to determine a plurality of rotation values from the information, the plurality of rotation values including two or more of the following: a value associated with a horizontal angle of the rotation, a value associated with a vertical angle of the rotation, a value associated with a direction of the rotation, a value associated with a velocity of the rotation, and a value associated with an acceleration of the rotation.

7. The image processing system of claim 1, further comprising a navigation device, and wherein determining the information indicative of the rotation includes combining information from the navigation device and the at least one sensor.

8. The image processing system of claim 1, wherein when the first section rotates in a first direction relative to the second section, the adjustment of the at least part of the image data includes correcting the at least part of the image data in an opposing second direction by an equal amount.

9. The image processing system of claim 1, wherein the top-view image includes a 360-degree view of the environment around the machine.

10. The image processing system of claim 1, wherein the environment includes at least one object and the top-view image presents a movement of the first section relative to at least one of the second section and the at least one object.

11. The image processing system of claim 1, wherein the top-view image presents the second section static while the first section rotates.

12. The image processing system of claim 1, wherein the environment includes at least one object and the top-view image presents the at least one object static while the first section rotates.

13. A method for displaying a top-view image of an environment around a machine having a first section pivotally connected to a second section, the method comprising:
capturing image data of the environment around the machine;
obtaining, from at least one sensor, information indicative of a rotation of the first section relative to the second section;
based on the information, adjusting at least part of the image data to account for the rotation of the first section relative to the second section;
using the adjusted image data to generate a top-view image of the environment around the machine; and
rendering the top-view image for display.

14. The method of claim 13, wherein the method further includes determining a plurality of rotation values from the information, the plurality of rotation values including two or more of the following: a value associated with a horizontal angle of the rotation, a value associated with a vertical angle of the rotation, a value associated with a direction of the rotation, a value associated with a velocity of the rotation, and a value associated with an acceleration of the rotation.

15. The method of claim 13, wherein determining information indicative of the rotation includes combining information from a navigation device and the at least one sensor.

16. The method of claim 13, wherein the top-view image includes a 360-degree view around the machine.

17. The method of claim 13, wherein the environment includes at least one object and the top-view image presents a movement of the first section relative to at least one of the second section and the at least one object.

18. The method of claim 13, wherein the top-view image presents the second section static while the first section rotates.

19. The method of claim 13, wherein the environment includes at least one object and the top-view image presents the at least one object static while the first section rotates.

20. A computer programmable medium having executable instructions stored thereon for completing a method for displaying a top-view image of an environment around a machine having a first section pivotally connected to a second section, the method comprising:
capturing image data of the environment around the machine;
obtaining, from at least one sensor, information indicative of a rotation of the first section relative to the second section;
based on the information, adjusting at least part of the image data to account for the rotation of the first section relative to the second section;
using the adjusted image data to generate a top-view image of the environment around the machine; and
rendering the top-view image for display.
